(19) United States
(12) Patent Application Publication
(10) Pub. No.: US 2025/0036188 A1
(43) Pub. Date: Jan. 30, 2025

(54) POWER REDUCTION BY REMOVAL OF REDUNDANCY IN CLOCK PATHWAYS OF VLSI CIRCUITS

(71) Applicant: INTERNATIONAL BUSINESS MACHINES CORPORATION, ARMONK, NY (US)

(72) Inventors: ANTON TCHAPLIANKA, TEL AVIV (IL); LIOR ARIE, RISHON LEZION (IL); RAHUL M. RAO, BANGALORE (IN)

(21) Appl. No.: 18/357,244

(22) Filed: Jul. 24, 2023

(51) Int. Cl. G06F 1/324

(52) U.S. Cl. CPC G06F 1/324

(57) ABSTRACT

Methods, systems, and products for power reduction by removal of redundancy in clock pathways of VLSI circuits includes: calculating, based on a circuit design data file, a timing budget for an LCB (local clock buffer) and an associated group of latches receiving a clock signal from the LCB, where the circuit design data file includes a structural representation of a circuit design and timing data, identifying, based on the timing budget, a delay element to remove, the delay element included within a delay element chain associated with the LCB, and removing the delay element from the circuit design.

### BACKGROUND

### Field of the Disclosure

The field of the disclosure is data processing, or, more specifically, methods, systems, and products for power reduction by removal of redundancy in clock pathways of VLSI circuits.

### Description of Related Art

VSLI circuits are designed and programmed before manufacture. Often the initial programmed design may include circuit elements that draw power but are not completely necessary for operation. Removing these excess circuit elements can help to reduce power consumption for the circuit.

### SUMMARY

Methods and systems for power reduction by removal of redundancy in clock pathways of VLSI circuits according to various embodiments are disclosed in this specification. In accordance with one aspect of the present disclosure, a method of power reduction by removal of redundancy in clock pathways of VLSI circuits may include calculating, based on a circuit design data file, a timing budget for an LCB (local clock buffer) and an associated group of latches receiving a clock signal from the LCB, where the circuit design data file includes a structural representation of a circuit design and timing data, identifying, based on the timing budget, a delay element to remove, the delay element included within a delay element chain associated with the LCB, and removing the delay element from the circuit design.

In accordance with another aspect of the present disclosure, operating a VRD at peak efficiency may include a system including: a processor, and non-volatile memory operatively coupled to the processor and including an application, the application configured to calculate, based on a circuit design data file, a timing budget for an LCB and an associated group of latches receiving a clock signal from the LCB, where the circuit design data file comprises a structural representation of a circuit design and timing data, identify, based on the timing budget, a delay element to remove, the delay element included within a delay element chain associated with the LCB, and remove the delay element from the circuit design.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a system configured for power reduction by removal of redundancy in clock pathways of VLSI circuits in accordance with embodiments of the present disclosure.

FIG. 2 shows an example diagram of a circuit configured for power reduction in clock pathways.

FIG. 3 is a flowchart of an example method for power reduction by removal of redundancy in clock pathways of VLSI circuits according to some embodiments of the present disclosure.

FIG. 4 is a flowchart of an example method for power reduction by removal of redundancy in clock pathways of VLSI circuits according to some embodiments of the present disclosure.

### DETAILED DESCRIPTION

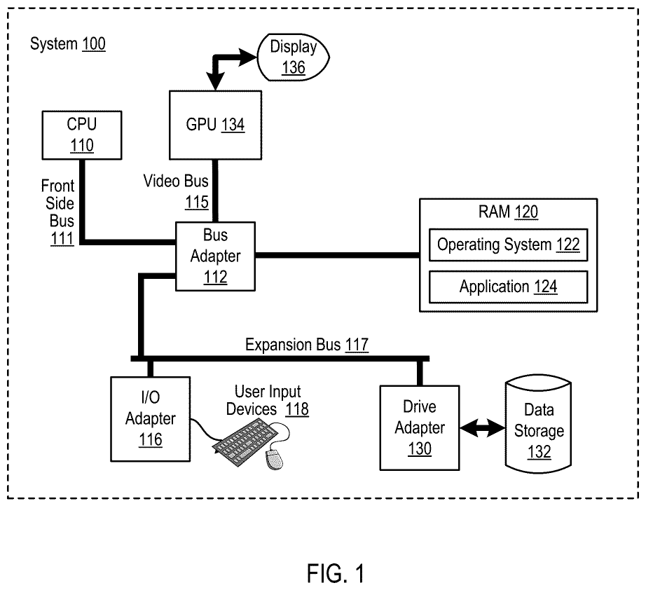

Exemplary methods, systems, and products for power reduction by removal of redundancy in clock pathways of VLSI circuits in accordance with the present disclosure are described with reference to the accompanying drawings, beginning with FIG. 1. FIG. 1 sets forth an example system configured for power reduction by removal of redundancy in clock pathways of VLSI circuits in accordance with embodiments of the present disclosure. The example system 100 of FIG. 1 includes a CPU (central processing unit) 110, a GPU 134 (graphics processing unit), and RAM (random access memory) 120 which is connected through a high speed memory bus and bus adapter 112 to CPU 110 and to other components of the system 100.

Stored in RAM 120 is an operating system 122. Operating systems useful in computers configured for power reduction by removal of redundancy in clock pathways of VLSI circuits according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive.

The system 100 of FIG. 1 includes disk drive adapter 130 coupled through expansion bus 117 and bus adapter 112 to CPU 110 and other components of the system 100. Disk drive adapter 130 connects non-volatile data storage to the system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, Flash drive, electrically erasable programmable read-only memory (‘EEPROM’), RAM drives, and so on, as will occur to those of skill in the art.

The example system 100 of FIG. 1 includes one or more input/output (′I/O′) adapters 116. I/O adapters implement user-oriented input/output through, for example, software drivers and computer hardware for controlling output to display devices such as computer display screens, as well as user input from user input devices 118 such as keyboards and mice. The example system 100 of FIG. 1 includes a GPU 134, which is an example of an I/O adapter specially designed for graphic output to a display device 136 such as a display screen or computer monitor. GPU 134 is connected to CPU 110 through a high speed video bus 115, bus adapter 112, and the front side bus 111, which is also a high speed bus.

Also stored in RAM is application 124. Application 124 is configured for power reduction by removal of redundancy in clock pathways of VLSI circuits according to embodiments of the present disclosure. Application 124 is configured to improve circuit designs, such as in very large-scale integration (VSLI) circuits, by removing unnecessary delay elements included within the circuit design. VLSI is the process of creating an integrated circuit (IC) by combining millions or billions of transistors onto a single chip. VSLI circuit designs are first programmed and then tested before being manufactured. Data describing a programmed circuit design, such as the structural representation of the circuit, may be included within a circuit design data file or specification, which may be tested in various ways before the circuit design is fabricated. One form of testing is by testing the timing of the circuit design, where the timing data obtained may be included within the circuit design data file. Timing data may include any timing information regarding the circuit design, such as slack data for each of the latches included within the circuit, slack data for each LCB (local clock buffer) providing clock signals to latch groups, and other timing data.

Some VSLI designs may implement cycle stealing, which is a method of accessing computer memory, such as RAM, or bus without interfering with the CPU. Exploitation of specific CPU or bus timings can permit the CPU to run at full speed without any delay if external devices access memory not actively participating in the CPU's current activity and complete the operations before any possible CPU conflict. Cycle stealing involves delaying the clock that feeds the latches in case the data to the latches fails setup time. Delaying the arrival time of the clock includes adding delay elements, such as delay devices, circuits, buffers, or other similar delay elements into the clock pathway in order to create the delay. Unfortunately, these additional delay elements often employ more transistors, which in turn consume more power. Because these delay elements are added between the global clock and the local clock buffer (LCB), they are always switching along with the clock and consume idle power in addition to leakage power.

When a circuit design is created implementing cycle stealing, the amount of delay elements added during the initial design process may not be optimal and may include more delay elements than is required for operation. Application 124 is configured to identify which delay elements can be removed without sacrificing performance of the circuit design, thereby reducing power consumption of the circuit design. The application 124 of FIG. 1 is described as a stand-alone application within RAM. In other embodiments, application 124 may be implemented in various other forms, such as a script, a web-based service, or an add-in to the EDA (electronic design automation) software, such as Cadence.

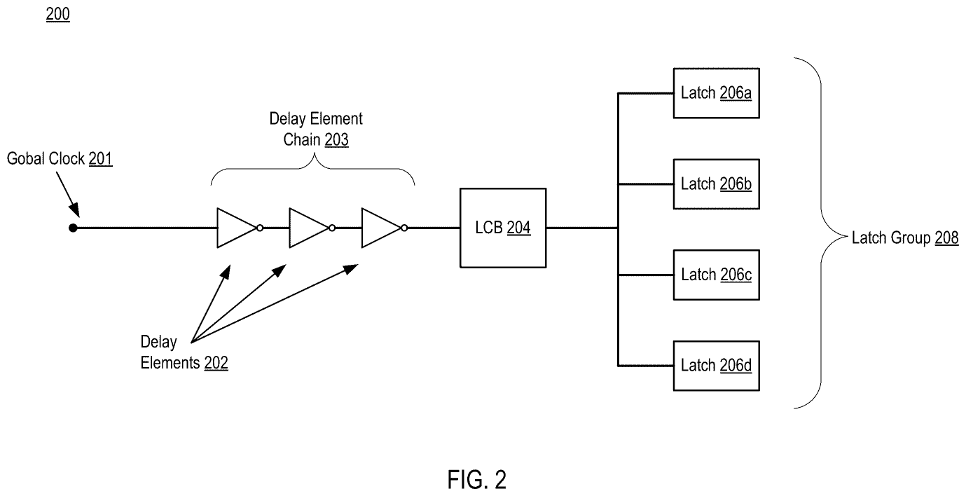

For further explanation, FIG. 2 sets forth an example circuit for power reduction in clock pathways in accordance with embodiments of the present disclosure. Such a circuit 200 may be a VSLI circuit and may be programmed or optimized by application 124 of FIG. 1. The example circuit 200 of FIG. 2 includes a global clock 201, delay elements 202 included within a delay element chain 203, an LCB 204 providing a modified clock signal to a group of latches, the group of latches (latch group 208) including latch 206a, latch 206b, latch 206c, and latch 206d. In FIG. 2, the example circuit 200 includes a single LCB with an associated group of latches and delay element chain. In other embodiments, the circuit may include multiple LCBs each having an associated latch group, where multiple of the LCBs have an associated delay element chain having one or more delay elements 202.

A local clock buffer, such as LCB 204, is a component that distributes clock signals. A typical clock control system has a clock generation circuit (such as a phase-lock loop (PLL) circuit) that generates a master clock signal, which is fed to a clock distribution network that renders synchronized global clock signals, such as global clock 201, at the LCBs. Each LCB adjusts the global clock duty cycle and edges to meet the requirements of respective circuit elements, such as local logic circuits or latches. That is, each latch within latch group 208 receives an adjusted clock signal from LCB 204.

The delay element chain may include one or more delay elements designed to delay the global clock before it reaches the LCB and the associated latch group. An example delay element 202 of FIG. 2 is a NOT gate (or inverter) which outputs a zero when given a one, and a one when given a zero. In other embodiments, the delay elements may be any other type of gate or buffer. Each delay element may delay the clock by a certain delay value and each delay value of the delay elements may be different from one another. The delay value of each delay element within a given delay element chain, as well as the total delay value of the delay element chain, may be included within the timing data of the circuit design data file.

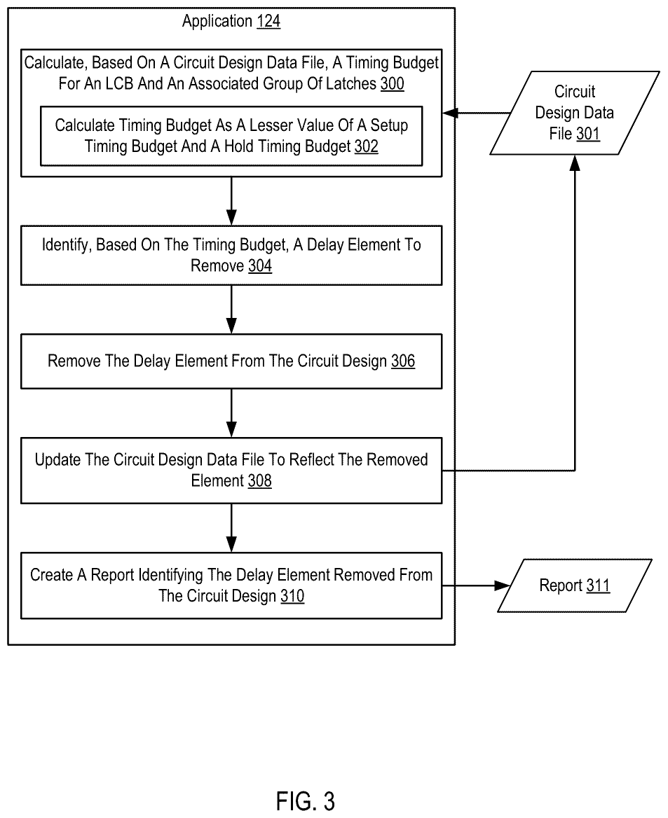

For further explanation, FIG. 3 sets forth a flow chart illustrating an exemplary method of power reduction by removal of redundancy in clock pathways of VLSI circuits according to embodiments of the present disclosure. The method of FIG. 3 includes calculating 300, based on a circuit design data file 301, a timing budget for an LCB and an associated group of latches. The circuit design data file 301 may be received by, or generated by, application 124 and may include a structural representation of the circuit design and timing data about the circuit design. Calculating 300, a timing budget for the LCB and associated latch group may be carried out by application 124 using the timing data included within the circuit design data file 301. The timing data may be obtained after testing, such as performing (by application 124 or some other application or device) a timing run on the circuit design and may include delay values for each of the delay elements within the delay element chain (as well as the total delay value for the delay element chain) and slack values for each of the latches within the latch group (as well as the total slack value for the latch group). Slack is the amount of margin by which timing requirements (such as setup time and hold time) are met.

Setup time is the minimum amount of time before the clock's active edge that the data, or control signal, must be stable for it to be latched correctly. In other words, each flip-flop (or any sequential element or latch, in general) needs some time for the data to remain stable before the clock edge arrives, such that it can reliably capture the data. Hold time is the minimum amount of time after the clock's active edge during which data must be stable. Similar to setup time, each sequential element needs some time for data to remain stable after clock edge arrives to reliably capture data.

Slack values for each latch include a setup slack value and a hold slack value. Setup slack and hold slack are the amount of margin by which the setup time and hold time, respectively, are met. A positive slack value is the amount of time by which the setup or hold timing requirement is met or exceeded. A negative slack value is the amount of time by which the setup or hold timing requirement is not met. Consider an example where the setup time is equal to 15 ns (nanoseconds) and a data signal at a latch becomes stable 17 ns before the clock leading edge arrives at the latch. In such an example, the latch has a setup slack value of 2 ns, where the setup slack value is positive since the setup time requirement was met and exceeded. If the data signal became stable only 14 ns before the clock leading edge arrived at the latch, the setup slack value for the latch would be −1 ns and would be negative since the setup time requirement was not met. In another example, the hold time is equal to 10 ns and a data signal at a latch remains stable 13 ns after the clock leading edge arrives at the latch. In such an example, the latch has a hold slack value of 3 ns, where the hold slack value is positive since the hold time requirement was met and exceeded. If the data signal remained stable only 8 ns after the clock leading edge arrived at the latch, the hold slack value for the latch would be −2 ns and would be negative since the hold time requirement was not met. A slack value is equal to zero when the timing requirement is met with no margin.

The method of FIG. 3 also includes, as part of calculating 300 a timing budget, calculating 302 the timing budget as a lesser value of a setup timing budget and a hold timing budget. Calculating the setup timing budget includes determining a setup slack value for each latch within the group of latches associated with the LCB. The setup timing budget is calculated as being equal to a smallest setup slack value within the group of latches when every setup slack value within the group of latches exceeds setup timing requirements (where every setup slack value of the latch group is considered a positive setup slack value). However, when any setup slack value within the group of latches meets the setup timing requirements without excess or does not meet the setup timing requirements at all (where one or more of the setup slack values is not positive), the setup timing budget is equal to zero.

Similarly, calculating the hold timing budget includes determining a hold slack value for each latch within the group of latches associated with the LCB. The hold timing budget is calculated as being equal to a smallest hold slack value within the group of latches when every hold slack value within the group of latches exceeds hold timing requirements (where every hold slack value of the latch group is considered a positive hold slack value). However, when any hold slack value within the group of latches meets the hold timing requirements without excess or does not meet the hold timing requirements at all (where one or more of the hold slack values is not positive), the hold timing budget is equal to zero.

The method of FIG. 3 also includes identifying 304, based on the timing budget, a delay element to remove. Identifying 304, based on the timing budget, a delay element to remove may be carried out by application 124 determining, using the timing data within the circuit design data file, which delay element or delay elements can be removed from the delay element chain without sacrificing performance or without interfering with the circuit's ability to carry out cycle stealing. Identifying 304 a delay element to remove includes comparing the delay value of a delay element with the timing budget and identifying the delay element as one to remove if the delay value of the delay element is less than or equal to the timing budget.

Consider an example circuit design, such as circuit 200 of FIG. 2, having a latch group 208 with slack values. If the setup slack values of latch group 208 are all positive (and thus meet the setup timing requirement) and are equal to 4 ns, 3 ns, 7 ns, and 2 ns, the setup timing budget is calculated as equal to 2 ns (the smallest setup slack value). If the hold slack values of latch group 208 are all positive (and thus meet the hold timing requirement) and are equal to 3 ns. 6 ns, 4 ns, and 5 ns, the hold timing budget is calculated as equal to 3 ns (the smallest hold slack value). Because the timing budget is equal to a lesser value of the setup timing budget and the hold timing budget, the timing budget of such an example latch group 208 is equal to 2 ns (from the setup timing budget).

Continuing with the above example, the delay elements 202 of FIG. 2 may have delay values of 3, ns, 5 ns, and 1.5 ns. In such an example, application 124 may identify the delay element having a delay value of 1.5 ns as a delay element to be removed, since the delay element has a delay value less than or equal to the timing budget of 2 ns.

The method of FIG. 3 also includes removing 306 the delay element from the circuit design. Removing 306 the delay element from the circuit design may be carried out by application 124 in response to identifying the delay element to remove. For example, after determining which delay element to remove, application 124 may remove the delay element from the circuit design data file, thereby reducing power consumption of the circuit design.

The method of FIG. 3 also includes updating 308 the circuit design data file to reflect the removed element. Updating 308 the circuit design data file may be carried out by application 124 updating the structural representation within the circuit design data file to no longer include the removed delay element. In updating the circuit design data file, the circuit created from such a design will have reduced power consumption compared to the original circuit designs implementing cycle stealing.

The method of FIG. 3 also includes creating 310 a report 311 identifying the delay element removed from the circuit design. Creating 310 a report 311 identifying the delay element removed from the circuit design may be carried out by application 124 generating a report file identifying the delay element that was removed from the circuit design and storing the report in memory. The report may also identify the LCB associated with the removed delay element and may also identify the specific delay element within the delay element chain. The report may be updated each time a delay element is removed from the circuit design. The report may be sent to a user in order to update the user about the updated circuit design data file or to improve future circuit designs in order to have less excess delay elements in future designs. In an example embodiment where the circuit design includes multiple LCBs, the steps of FIG. 3 may be carried out for each of the LCBs within the circuit design having an associated delay element chain.

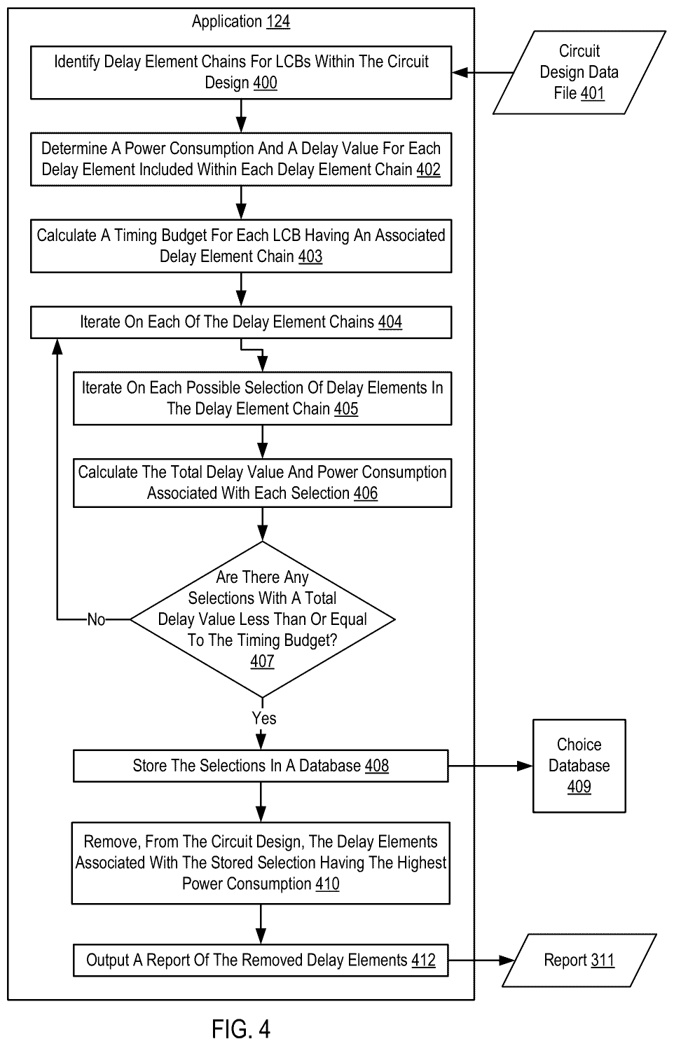

For further explanation, FIG. 4 sets forth a flowchart illustrating another example method of power reduction by removal of redundancy in clock pathways of VLSI circuits according to embodiments of the present disclosure. The method of FIG. 4 includes identifying 400 delay element chains for LCBs within the circuit design. Identifying 400 delay element chains for LCBs within the circuit design may be carried out by application 124 based on the circuit design data file, which includes a structural representation of the circuit design, including information describing any LCBs within the circuit that have a corresponding delay element chain. The application 124 may parse the circuit design data file in order to determine which LCBs have an associated delay element chain.

The method of FIG. 4 also includes determining 402 a power consumption and a delay value for each delay element included within each delay element chain. Determining 402 a power consumption and a delay value for each delay element included within each delay element chain may be carried out by application 124 using the timing data included within the circuit design data file 401. Each delay element may delay the clock by a certain delay value and each delay value of the delay elements may be different from one another. The delay value of each delay element within a given delay element chain, as well as the total delay value of each delay element chain, may be included within the timing data of the circuit design data file 401. Each delay element may also consume an amount of power and the circuit design data file 401 may specify the amount of power consumed by each delay element.

The method of FIG. 4 also includes calculating 403 a timing budget for each LCB having an associated delay element chain. Calculating 403 a timing budget for each LCB having an associated delay element chain may be carried out by application 124 using the timing data included within the circuit design data file 401. Calculating 403 a timing budget may be carried out in the same way as described above in reference to FIG. 3 and may be carried out for each LCB within the circuit design having an associated delay element chain with one or more delay elements.

The method of FIG. 4 also includes iterating 404 on each of the delay element chains. That is, each of the remaining steps of FIG. 4 will be carried out iteratively for every delay element chain within the circuit design.

The method of FIG. 4 also includes iterating 405 on each possible selection of delay elements in the given delay element chain. That is, each of the remaining steps of FIG. 4 will be carried out iteratively for every possible selection of delay elements within the given delay element chain. A selection of delay elements may include one or more, or even all, of the delay elements included within the delay element chain.

The method of FIG. 4 also includes, iteratively for every possible selection of delay elements within the given delay element chain, calculating 406 the total delay value and power consumption associated with each selection. Calculating 406 the total delay value associated with each selection may be carried out by application 124 combining the delay values of the one or more delay elements included within a given selection to determine a total delay value for each selection. Calculating 406 the total power consumption associated with each selection may be carried out by application 124 combining the power consumption values of the one or more delay elements included within a given selection to determine a total power consumption for each selection.

The method of FIG. 4 also includes, iteratively for every delay element chain within the circuit design, determining 407 whether there are any selections with a total delay value less than or equal to the timing budget. Determining 407 whether there are any selections with a total delay value less than or equal to the timing budget may be carried out by application 124 comparing the total delay value, iteratively for each possible selection, of a selection with the timing budget and identifying any selections having a total delay value less than or equal to the timing budget.

The method of FIG. 4 also includes, if there are any selections with a total delay value less than or equal to the timing budget, storing 408 those selections in a database. Storing 408, in a database 409, the selections having a total delay value less than or equal to the timing budget may be carried out by application 124. For example, if there are seven possible selections within the delay element chain and only three of the possible selections are determined as having a delay value less than or equal to the timing budget, those three selections will be stored within database 409. If application 124 determines that there are not any selections with a total delay value less than or equal to the timing budget, the application 124 will iterate to the next delay element chain within the circuit design and proceed with the method of FIG. 4 by again iterating 405 on each possible selection within the next delay element chain.

The method of FIG. 4 also includes, if there are any selections with a total delay value less than or equal to the timing budget, removing 410, from the circuit design, the delay elements associated with the stored selection having the highest power consumption. Removing 410, from the circuit design, the delay elements associated with the stored selection having the highest power consumption may be carried out by application 124 comparing each of the power consumption values associated with each of the selections stored within the database and determining to remove the selection having the highest power consumption value. Continuing with the above example, if there are three selections stored within the database, each selection having a delay value less than or equal to the timing budget, only the selection within the database having the highest power consumption value will be removed from the circuit design.

The method of FIG. 4 also includes outputting 412 a report of the removed delay elements. Outputting 412 a report of the removed delay elements may be carried out by application 124 creating or updating a report 311 that specifies which delay elements are being removed from the given delay element chain. In one embodiment, multiple reports may be created, with each report being associated with a different delay element chain. In another embodiment, one report is created and continually updated with each iteration of delay element chains so that the report includes every delay element being removed from each and every delay element chain included within the circuit design.

By iterating on every delay element chain within the circuit design, the method of FIG. 4 effectively removes excess delay elements within the circuit design that is not required in order to meet the timing requirements of the circuit and its components and without sacrificing performance or cycle stealing capabilities. Further, the method of FIG. 4 optimizes power reduction by determining which removed delay elements will most greatly reduce the power consumption of the circuit design. As there may be many different delay element chains within a VSLI circuit design, with each delay element chain including potentially multiple different delay elements, by removing the excess delay elements within the circuit according to the method of FIG. 4, application 124 may significantly reduce power consumption of the circuit design.

In view of the explanations set forth above, readers will recognize that the benefits of power reduction by removal of redundancy in clock pathways of VLSI circuits according to embodiments of the present disclosure include:
Significantly reducing the amount of power consumption required for circuits created using VLSI designs that may implement cycle stealing.
Increasing VSLI circuit design efficiency.

The flowchart and block diagrams in the Figures illustrate the architecture, functionality, and operation of possible implementations of systems, methods, and apparatus according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments of the present disclosure are described largely in the context of a fully functional computer system for dynamic buffer selection in ethernet controllers. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of power reduction by removal of redundancy in clock pathways of VLSI circuits, the method comprising:
calculating, based on a circuit design data file, a timing budget for an LCB (local clock buffer) and an associated group of latches receiving a clock signal from the LCB, wherein the circuit design data file comprises a structural representation of a circuit design and timing data;
identifying, based on the timing budget, a delay element to remove, the delay element included within a delay element chain associated with the LCB; and
removing the delay element from the circuit design.

2. The method of claim 1, further comprising creating a report identifying the delay element removed from the circuit design.

3. The method of claim 1, further comprising updating the circuit design data file to reflect the removed delay element.

4. The method of claim 1, wherein the delay element chain is positioned between a global clock and the LCB.

5. The method of claim 1, wherein the circuit design includes a plurality of LCBs with associated groups of latches and the steps of calculating, identifying, and removing are performed for each of the plurality of LCBs within the circuit design.

6. The method of claim 1, wherein calculating the timing budget comprises calculating the timing budget as a lesser value of a setup timing budget and a hold timing budget.

7. The method of claim 6, further comprising:
calculating the setup timing budget including determining a setup slack value for each latch within the group of latches associated with the LCB; and
calculating the hold timing budget including determining a hold slack value for each latch within the group of latches associated with the LCB.

8. The method of claim 7, wherein calculating the setup timing budget comprises:
calculating the setup timing budget as equal to a smallest setup slack value within the group of latches when every setup slack value within the group of latches exceeds setup timing requirements; and
calculating the setup timing budget as zero when any setup slack value within the group of latches meets the setup timing requirements without excess or does not meet the setup timing requirements at all.

9. The method of claim 7, wherein calculating the hold timing budget comprises:
calculating the hold timing budget as equal to a smallest hold slack value within the group of latches when every hold slack value within the group of latches exceeds hold timing requirements; and
calculating the hold timing budget as zero when any hold slack value within the group of latches meets the hold timing requirements without excess or does not meet the hold timing requirements at all.

10. The method of claim 1, wherein identifying the delay element to remove further comprises calculating a total delay value and a power consumption associated with each of a plurality of possible selections of delay elements included within the delay element chain.

11. The method of claim 10, further comprising storing, in a database, each of the plurality of possible selections whose total delay value is less than or equal to the timing budget.

12. The method of claim 11, further comprising removing, from the circuit design, the delay elements associated with a stored selection of the plurality of possible selections having a highest power consumption.

13. A system for power reduction by removal of redundancy in clock pathways of VLSI circuits, the system comprising:
a processor; and
non-volatile memory operatively coupled to the processor and including an application, the application configured to:
calculate, based on a circuit design data file, a timing budget for an LCB (local clock buffer) and an associated group of latches receiving a clock signal from the LCB, wherein the circuit design data file comprises a structural representation of a circuit design and timing data;
identify, based on the timing budget, a delay element to remove, the delay element included within a delay element chain associated with the LCB; and
remove the delay element from the circuit design.

14. The system of claim 13, wherein calculating the timing budget comprises calculating the timing budget as a lesser value of a setup timing budget and a hold timing budget.

15. The system of claim 14, further comprising:
calculating the setup timing budget including determining a setup slack value for each latch within the group of latches associated with the LCB; and
calculating the hold timing budget including determining a hold slack value for each latch within the group of latches associated with the LCB.

16. The system of claim 15, wherein calculating the setup timing budget comprises:
calculating the setup timing budget as equal to a smallest setup slack value within the group of latches when every setup slack value within the group of latches exceeds setup timing requirements; and
calculating the setup timing budget as zero when any setup slack value within the group of latches meets the setup timing requirements without excess or does not meet the setup timing requirements at all.

17. The system of claim 15, wherein calculating the hold timing budget comprises:
calculating the hold timing budget as equal to a smallest hold slack value within the group of latches when every hold slack value within the group of latches exceeds hold timing requirements; and
calculating the hold timing budget as zero when any hold slack value within the group of latches meets the hold timing requirements without excess or does not meet the hold timing requirements at all.

18. The system of claim 13, wherein identifying the delay element to remove further comprises calculating a total delay value and a power consumption associated with each of a plurality of possible selections of delay elements included within the delay element chain.

19. The system of claim 18, further comprising:
storing, in a database, each of the plurality of possible selections whose total delay value is less than or equal to the timing budget; and
removing, from the circuit design, the delay elements associated with a stored selection of the plurality of possible selections having a highest power consumption.

20. A computer program product for power reduction by removal of redundancy in clock pathways of VLSI circuits, the computer program product comprising a non-volatile computer readable medium and computer program instructions stored therein that are configured to, when executed, cause a computer to perform operations comprising:
calculating, based on a circuit design data file, a timing budget for an LCB (local clock buffer) and an associated group of latches receiving a clock signal from the LCB, wherein the circuit design data file comprises a structural representation of a circuit design and timing data;
identifying, based on the timing budget, a delay element to remove, the delay element included within a delay element chain associated with the LCB; and
removing the delay element from the circuit design.
